(19) United States
(12) Patent Application Publication
(10) Pub. No.: US 2004/0048035 A1
(43) Pub. Date: Mar. 11, 2004

(54) Recyclable floor mats, methods and systems for recycling floor mats

(75) Inventors: Bob Bailey, Charlton, NY (US); Wayne F. Allen, Ballston Lake, NY (US)

Correspondence Address: HESLIN ROTHENBERG FARLEY & MESITI PC, 5 COLUMBIA CIRCLE, ALBANY, NY, 12203, US

(73) Assignee: Racemark International, Inc., Malta, NY

(21) Appl. No.: 10/236,774

(22) Filed: Sep. 6, 2002

(51) Int. Cl. B32B 3/02

(52) U.S. Cl. 428/95; 428/97; 428/96; 428/903.3

(57) ABSTRACT

A recyclable floor mat includes indicia to aid in the collection and sorting of the recyclable floor mat. For example, a recyclable vehicle floor mat may be provided with a green colored bottom surface for readily identifying to car owners and car dealers that the vehicle floor mat is recyclable. A method and system for collecting and recycling vehicle floor mats may include car dealers, a parts distribution center, a recycle center, and a vehicle floor mat manufacturer.

### FIELD OF THE INVENTION

The present invention relates generally to floor mats, and more particularly to recyclable floor mats, and methods and systems for recycling floor mats.

### BACKGROUND OF THE INVENTION

Car dealers typically provide vehicle floor mats with the purchase of a new car. After awhile, the vehicle floor mats may become worn and are replaced with new vehicle floor mats which typically can be purchased at an automobile parts store or a car dealer. Car owners often discard worn out vehicle floor mats in the trash.

An attempt has been made at providing recyclable vehicle floor mats having an upper carpet layer and a black bottom layer by selecting material from a common chemical family. This allows use of worn out recyclable vehicle floor mats as feedstock for forming new vehicle floor mats without requiring separation of the mat components.

There is a need for further recyclable floor mats, and further methods and systems for recycling floor mats.

### SUMMARY OF THE INVENTION

The present invention provides, in a first aspect, a recyclable floor mat which includes a layer of recyclable material, and indicia, disposed on the layer, identifying that the floor mat is recyclable.

The present invention provides, in a second aspect, a floor mat which includes a layer comprising an upper portion and a lower portion, and wherein at least one of the upper portion and the lower portion comprises recycled material and the upper portion being different from the lower portion.

The present invention provides, in a third aspect, a method for enabling recycling of floor mats in which the method includes obtaining a used floor mat, and providing an item of value in consideration for the used floor mat.

The present invention provides, in a fourth aspect, a method for recycling vehicle floor mats in which the method includes obtaining a used vehicle floor mat having indicia identifying that the vehicle floor mat is recyclable, and providing an item of value in consideration for the used vehicle floor mat.

The present invention provides, in a fifth aspect, a system for enabling recycling of floor mats. The system includes means for obtaining a used floor mat and means for providing an item of value in consideration for the used floor mat.

The present invention provides, in a sixth aspect, a system for enabling recycling of vehicle floor mats. The system includes means for obtaining a used vehicle floor mat and means for providing an item of value in consideration for the used vehicle floor mat.

### BRIEF DESCRIPTION OF THE DRAWINGS

The subject matter which is regarded as the invention is particularly pointed out and distinctly claimed in the concluding portion of the specification. The invention, however, may be understood by reference to the following detailed description of the following embodiments and the accompanying drawings in which:

FIG. 1 is a block diagram of a system for collecting and recycling vehicle floor mats in accordance with the present invention;

FIG. 2 is a flowchart of a method for enabling recycling of vehicle floor mats;

FIG. 3 is a perspective view of a recyclable vehicle floor mat in accordance with the present invention;

FIG. 4 is a partial cross-sectional view of a recyclable vehicle floor mat in accordance with the present invention;

FIG. 5 is another partial cross-sectional view of a recyclable vehicle floor mat in accordance with the present invention;

FIG. 6 is a partial cross-sectional view of a recyclable vehicle floor mat in accordance with the present invention;

FIG. 7 is a perspective view of a recyclable floor mat in accordance with the present invention; and

FIG. 8 is a flowchart of a method for enabling recycling of floor mats.

### DETAILED DESCRIPTION OF THE INVENTION

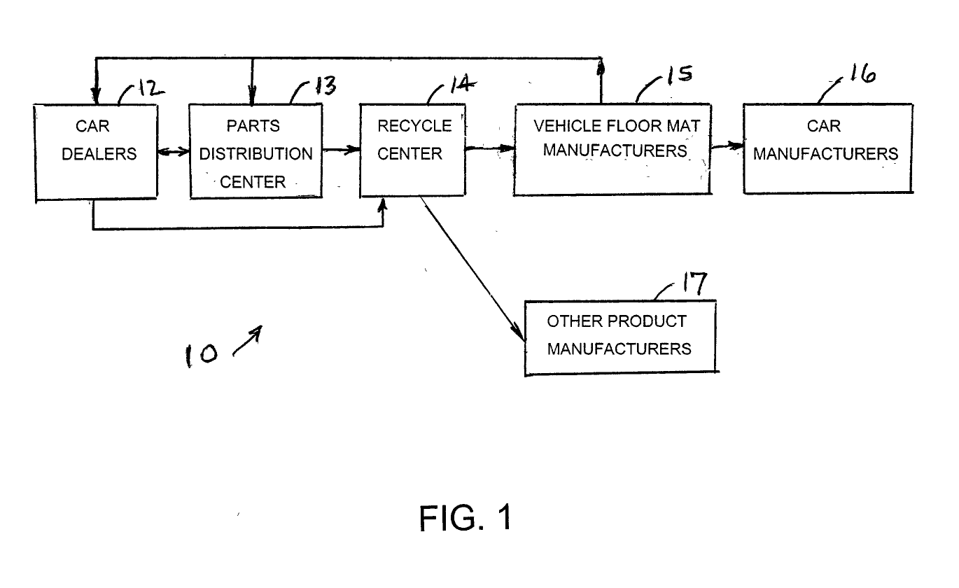

FIG. 1 illustrates a system 10 for collecting and recycling vehicle floor mats in accordance with the present invention. In one embodiment, system 10 generally includes car dealers 12 (only one of which is shown in FIG. 1), a parts distribution center 13, a recycle center 14, and a vehicle floor mat manufacturer 15. It will be appreciated that the system can incorporate more than one parts distribution center, recycle center, or vehicle floor mat manufacturer.

For example, the system allows car owners to return used recyclable vehicle floor mats to a car dealer. The collected used recyclable vehicle floor mats received by the various car dealers 12 are transferred to the car dealer's parts distribution center 13. Parts distribution center 13 then transfers the used recyclable vehicle floor mats to recycle center 14. Alternatively, the car dealers may transfer the collected used recycled vehicle floor mats to the recycle center.

Recycle center 14 may process, grind and/or melt, the used recyclable vehicle floor mats, preferably without the need for any component separation, to produce a fluff or form pellets or other forms which may be shipped to vehicle floor mat manufacture 15 for incorporation into new floor mats. New manufactured vehicle floor mats incorporating used recycled vehicle floor mats may be shipped from vehicle floor mat manufacturer 15 to car manufactures 16, car dealers 12, parts distribution center 13, or even back to the car owner.

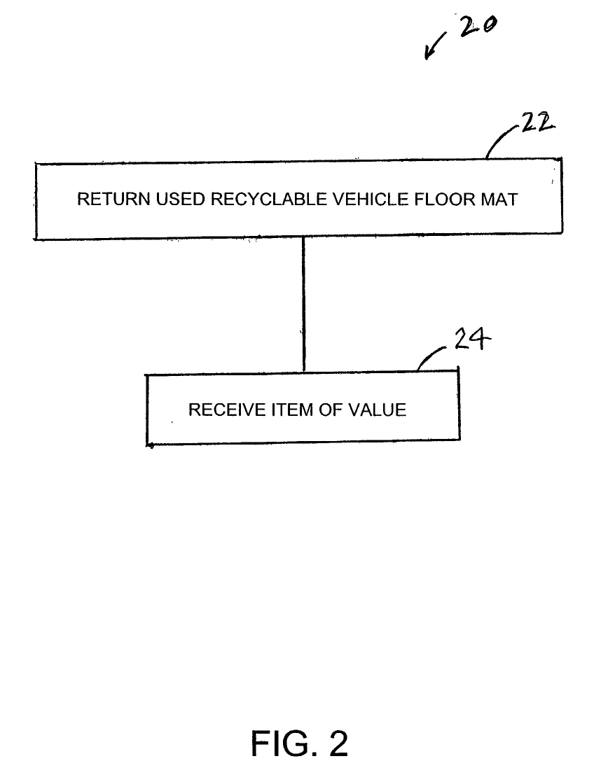

As shown in FIG. 2, a method 20 for enabling recycling of vehicle floor mats may include, at 22, the car owner returning used vehicle floor mats, and at 24, the car owner receiving an item of value. For example, the car owner may return the used vehicle floor mats to a car dealer (as shown in FIG. 1). Alternatively, the car owner may ship the used recyclable vehicle floor mats to a parts distribution center, to a recycle center, or to a vehicle floor mat manufacturer.

Upon purchase of a car, the car owner may be provided with instructions, e.g., in the owners manual or other information, regarding the recyclable vehicle floor mats, and the method of collecting and recycling of worn out recyclable vehicle floor mats. The car owner may also be provided with a listing of places for returning or mailing the recyclable floor mats once they are worn out.

The item of value provided as an incentive and/or consideration for return of the used recyclable floor mat may be money, an offer or incentive for new products, a credit toward new recyclable vehicle floor mats, a discount on a new car, a car related product, credit toward a purchase of a car related product, or other item or items of value.

For example, where a car owner returns the used vehicle floor mats to a car dealer, the car dealer is able to show the car owner the models of automobiles and offer a discount on the purchase of a new car. Where the car owner ships or mails the used recyclable floor mats to, e.g., a parts distribution center, a recycle center, or a vehicle floor mat manufacturer, the car owner may receive a credit or coupon for an item or items of value.

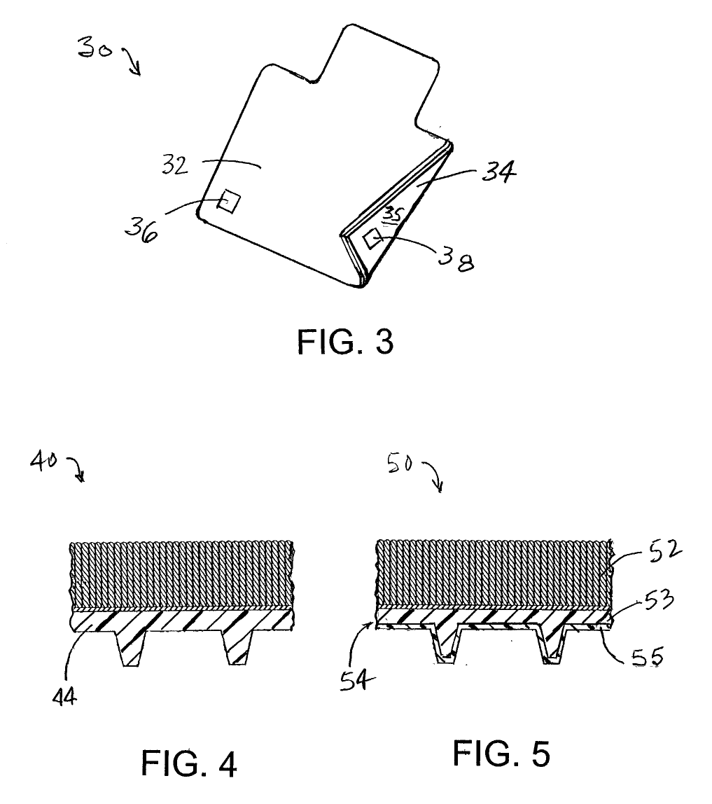

FIG. 3 illustrates a recyclable vehicle floor mat 30. It will be appreciated by those skilled in the art that the vehicle floor may have various other shapes or configurations than that illustrated in FIG. 3. In addition, the bottom surface of the recyclable vehicle floor mat may include downwardly-extending nibs (as shown in FIGS. 4 and 5) and/or other structure(s) to engage a carpeted vehicle floor board.

Generally, the recyclable vehicle floor mat includes a top face or layer 32 and a bottom backing or layer 34 attached to the top layer 32. For example, the recyclable vehicle floor mat may be formed from chemically compatible materials such as a polypropylene carpet material and a thermoplastic olefin backing material. It will be appreciated that other materials may be suitably employed. To aid in the collection and sorting of the recyclable vehicle floor mats, the recyclable vehicle floor mats may be provided with indicia for readily identifying to customers that the vehicle floor mats are recyclable and, to car dealers, for example, that the vehicle floor mats may be recycled according to the above described and illustrated collection and recycling process. Indicia 36 and 38 may include tags, labels, or logos disposed on the top layer or the bottom layer, respectively, of the recyclable vehicle floor mat.

The indicia may also be a bottom surface 35 of bottom layer 34 being provided with a color other than the conventional color black for vehicle floor mats. As shown in FIG. 4, a recyclable vehicle floor 40 mat may include the entire bottom backing 44 of recyclable vehicle floor mat 40 being formed of a green colored material. As shown in FIG. 5, in manufacturing a recyclable vehicle floor mat 50, a bottom layer 54 of recyclable floor mat 50 may be coextruded with an upper portion 53, e.g., about 80-percent of the thickness of bottom layer 54, and a lower portion 55 of bottom layer 54, e.g., about 20 percent of the thickness of the bottom layer; the latter portion 55 being a green colored material. Alternatively, the upper portion may comprises 10-percent to 50-percent of the bottom layer. It will be appreciated that the bottom layer may be formed of two or more layers. In addition, the recyclable floor mat of the present invention may include a single layer having incorporated therein recycled material and/or means or indicia for identifying that the floor mat is recyclable.

In addition, the bottom surface may include other suitable indicia, e.g., colored stripes, colored portions, etc., for readily identifying that the vehicle floor mat is recyclable and may be processed according to the above described and illustrated collection and recycling process.

Where recyclable vehicle floor mats are manufactured using used recycled vehicle floor mats as described above, the vehicle floor mat manufacturer may use, e.g., about 20-percent to about 30-percent of the recycled material in new recyclable vehicle floor mats. As shown in FIG. 5, where the regind is used for new vehicle floor mats, the regrind may be used in at least one of upper portion 53 and lower portion 55 of bottom layer. For example, the regrind may be used in upper portion 53 of bottom layer 54, and lower portion 55 may be formed from a virgin material. Using recycled material for a portion of the virgin materials normally used in the manufacture of new vehicle floor mats may reduce the cost of forming the new recyclable vehicle floor mats. The vehicle floor mat manufacture process may recycle trim or scrap, e.g., the carpeted upper layer and the bottom backing layer, and include the recycled trim or scrap into the recyclable vehicle floor mats. Recycling the trim or scrap eliminates the need and cost for disposing of the trim or scrap.

The manufacturing process of recyclable vehicle floor mats or other products may incorporate the recycling of products having materials with different melting temperatures. The recycling of used vehicle floor mats, trim, or other recycled products may include, for example, a nylon carpet having a TPO (thermoplastic olefin) backing. The process may includes grinding the used vehicle floor mats, trim, or other recycled products, heating the ground used vehicle floor mats, trim, or other recycled product to 350 degrees Fahrenheit to melt the TPO backing while not melting the nylon fiber yarn which has a 550-degree Fahrenheit melting point, and using the recycled material in new vehicle floor mats or other products. In other words, the process may reclaim the nylon fibers and use the fibers for strengthening new recyclable vehicle floor mats or other products.

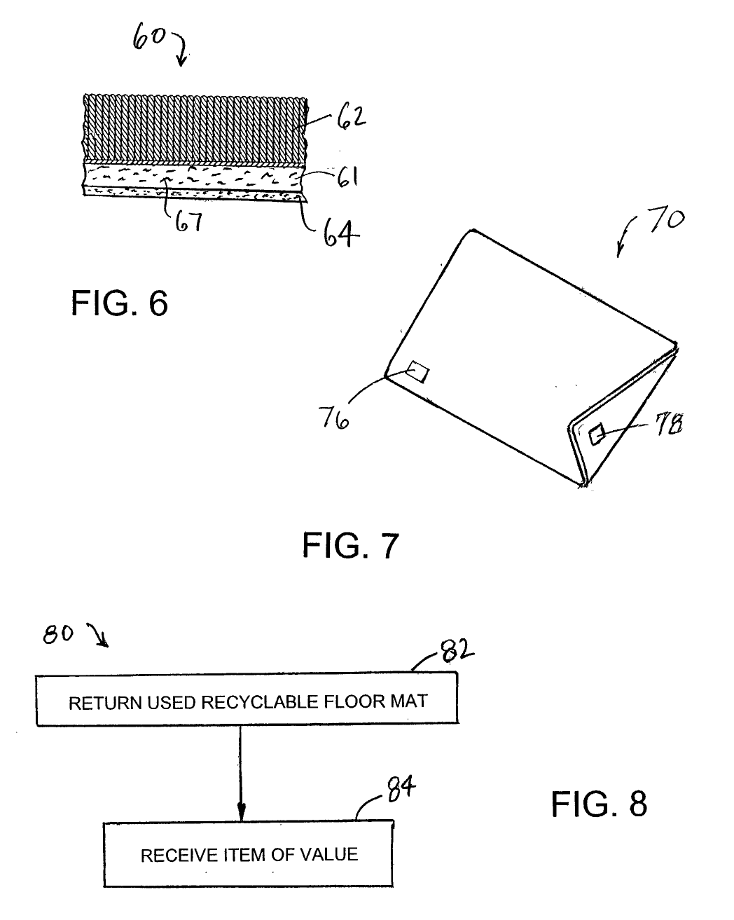

FIG. 6 illustrates an example of a floor mat having a carpet layer 62, a bottom layer 64, and a laminate layer 61 which bonds the carpet layer to the bottom layer. The carpet layer may be a nylon or polyester carpet layer, and the bottom layer may be polyurethane foam. The laminate layer may include recycled fibers 67 such as nylon fibers as described above. In addition, the laminate layer may be mixed with TPO, EPDM (ethylene propylene diene monomer), EVA (ethylene vinyl acetate), polyethylene, or copolymers of polyethylene with octene, butene, or hexene. The floor mat may also include a bottom green surface or indicia for indicating that the floor mat is recyclable. From the present description, it will be appreciated that the recycled fiber material described above may also be used in the forming of the bottom layers shown in FIGS. 3-5.

While the vehicle floor mat described above includes a carpeted upper layer and a bottom backing layer, the recyclable floor mat of the present invention may be formed of a single layer having recycled material. For example, the single layer may comprises a thermoplastic layer.

While FIG. 1 illustrates a generally closed loop recycling process incorporating car dealers and car manufacturers, it is also possible to supply recycled vehicle floor mats, e.g., the fluff or pellets, to manufacturers of other products 17.

It will be appreciated by those skilled in the art that the vehicle floor mats may be used in the passenger compartment of the vehicle, as well as in the trunk and in other locations of the vehicle. The vehicle may include automobiles, trucks, sports utility vehicles, and other vehicles. In addition, the present invention can also include other types of floor mats, e.g., welcome mats placed in front of a door to a residence or a business, and floor mats placed in a residence or a business. While reference is made to a car owner in the recycling process, it will be appreciated that the recycling process is also directed to others, for example, a leasee of a vehicle, a relative of a car owner, and other users, consumers, middlemen, organizations, and persons.

In addition, the above described system may also allow the return of other types of floor mats such as floor mats used in and outside homes and offices. FIG. 7 illustrates such a recyclable floor mat 70. It will be appreciated by those skilled in the art that the floor mat may have various other shapes or configurations than that illustrated in FIG. 7. Floor mat 70 may be formed of a single layer of recyclable material or two or more layers of recyclable material. To aid in the collection and sorting of the recyclable floor mats, recyclable floor mat 70 may be provided with indicia for readily identifying to customers that the floor mat is recyclable. Indicia 76 and 78 may include tags, labels, or logos disposed on the top or the bottom, respectively, of the recyclable floor mat. In addition, the bottom surface of the floor mat may be provided with a color such as described above in connection with the recyclable vehicle floor mat. In the manufacture of floor mat 70, a manufacturer may also use recycled material as described above in connection with the recyclable vehicle floor mat.

As shown in FIG. 8, a method 80 for enabling recycling of floor mats may include, at 82, the customer returning a used recyclable floor mat, and at 84, the customer receiving an item of value. For example, the customer may return the used floor mats to a car dealer or parts distribution center (as shown in FIG. 1), or to a retailer such as where the customer purchased the floor mat, or the customer may ship the used recyclable floor mats to a floor mat manufacturer. Upon purchase of the recyclable floor mat, the customer may be provided with instructions regarding the recyclable floor mat, and the method of collecting and recycling of worn out recyclable floor mats.

While the invention has been described in detail herein in accordance with certain embodiments thereof, many modifications and changes therein may be effected by those skilled in the art. Accordingly, it is intended by the appended claims to cover all such modifications and changes as fall within the true spirit and scope of the invention.

1. A recyclable floor mat comprising:
a layer of recyclable material; and
indicia, disposed on said layer, identifying that said floor mat is recyclable.

2. The recyclable floor mat of claim 1 wherein said indicia comprises at least one of a tag and a label.

3. The recyclable floor mat of claim 1 wherein said indicia comprises a portion of a bottom surface of said layer comprising a color other than black.

4. The recyclable floor mat of claim 1 wherein said indicia comprises a portion of a bottom surface of said layer comprising a green color.

5. The recyclable floor mat of claim 1 wherein said indicia comprises an entire bottom surface of said layer comprising a green color.

6. The recyclable floor mat of claim 1 wherein said layer comprises recycled used floor mats.

7. The recyclable floor mat of claim 1 wherein said layer comprises scrap obtained from forming floor mats.

8. The recyclable floor mat of claim 1 wherein said layer comprises recycled fiber material.

9. The recyclable floor mat of claim 1 wherein said layer comprises a coextruded layer in which a bottom surface comprises a green color defining said indicia.

10. The recyclable floor mat of claim 1 further comprising a carpet, said carpet being attached to said layer.

11. The recyclable floor mat of claim 10 wherein said layer and said carpet comprise compatible materials.

12. A floor mat comprising:
a layer comprising an upper portion and a lower portion; and
wherein at least one of said upper portion and said lower portion comprising recycled material and said upper portion being different from said lower portion.

13. The floor mat of claim 12 wherein said upper portion comprises about 80-percent of said layer.

14. The floor mat of claim 12 wherein said upper portion comprises about 10-percent to about 50-percent of said layer.

15. The floor mat of claim 12 wherein said recycled material comprises used floor mats.

16. The floor mat of claim 12 wherein said recycled material comprises scrap obtained from forming floor mats.

17. The floor mat of claim 12 wherein said layer comprises recycled fiber material.

18. The floor mat of claim 12 further comprising indicia, disposed on at least one of said top layer and said bottom layer, identifying that said floor mat is recyclable.

19. The floor mat of claim 18 wherein said indicia comprises at least one of a tag and a label.

20. The floor mat of claim 18 wherein said indicia comprises said lower portion comprising a color other than black.

21. The floor mat of claim 18 wherein said indicia comprises said lower portion comprising a green color.

22. The floor mat of claim 16 wherein said indicia comprises an entire bottom surface of said bottom layer comprising a green color.

23. The floor mat of claim 12 wherein said layers comprise compatible materials.

24. The floor mat of claim 12 further comprising a top layer comprises a carpet material, said top layer being attached to said upper portion of said layer.

25. A method for enabling recycling of floor mats, the method comprising:
obtaining a used floor mat; and
providing an item of value in consideration for the used floor mat.

26. The method of claim 25 further comprising identifying that the used floor mat is recyclable.

27. The method of claim 25 further comprising processing the used floor mat for use in a product.

28. A method for enabling recycling of vehicle floor mats, the method comprising:
obtaining a used vehicle floor mat having indicia identifying that the vehicle floor mat is recyclable; and
providing an item of value in consideration for the used vehicle floor mat.

29. The method of claim 28 further comprising processing the used vehicle floor mat for use in a product.

30. The method of claim 28 wherein the obtaining comprises obtaining the used vehicle floor mat from a person at a car dealer.

31. The method of claim 28 further comprising transferring the used vehicle floor mat to a recycle center, processing the used vehicle floor mat, and transferring the processed used vehicle floor mat to a manufacturer of products.

32. The method of claim 31 wherein the transferring the used vehicle floor mat to a recycle center comprises transferring the used vehicle floor mat from a car dealer to a parts distribution center and transferring the used vehicle floor mat from the parts distribution center to the recycle center.

33. The method of claim 28 wherein the item of value comprises at least one of money, a new floor mat, a car related product, credit toward a purchase of a car related product, and a product.

34. The method of claim 28 wherein the item of value comprises at least one of a car related product and credit toward a purchase of a car related product.

35. The method of claim 28 wherein the indicia comprises at least one of a tag and a label.

36. The method of claim 28 wherein the indicia comprises a portion of a bottom surface of the used vehicle floor mat comprising a color other than black.

37. The method of claim 28 wherein the indicia comprises a portion of a bottom surface of the used vehicle floor mat comprising a green color.

38. The method of claim 28 wherein the indicia comprises an entire bottom surface of the used vehicle floor mat comprising a green color.

39. The method of claim 28 wherein the used vehicle floor mat comprises recycled used vehicle floor mats.

40. The method of claim 28 wherein the used vehicle floor mat comprises scrap obtained from forming vehicle floor mats.

41. The method of claim 28 wherein the used vehicle floor mat comprises recycled fiber material.

42. The method of claim 28 wherein the used recyclable vehicle floor mat comprises a bottom layer comprising a co-extruded layer in which a bottom surface comprises a green color defining said indicia.

43. The method of claim 28 wherein the used vehicle floor mat comprises a top carpeted layer and a bottom layer attached to the top layer, and wherein the layers comprise compatible materials.

44. A system for enabling recycling of floor mats, said system comprising:
means for obtaining a used floor mat; and
means for providing an item of value in consideration for said used floor mat.

45. The system of claim 44 further comprising means for identifying said used vehicle floor mat as being recyclable.

46. The system of claim 44 further comprising means for processing said used recyclable floor mat for use in a product.

47. A system for enabling recycling of vehicle floor mats, said system comprising:
means for obtaining a used vehicle floor mat; and
means for providing an item of value in consideration for said used vehicle floor mat.

48. The system of claim 47 further comprising means for identifying said used vehicle floor mat as being recyclable.

49. The system of claim 47 further comprising means for processing said used recyclable vehicle floor mat for use in a product.

50. The system of claim 47 wherein said item of value comprises at least one of money, a new floor mat, a car related product, credit toward a purchase of a car related product, and a product.

51. The system of claim 47 wherein said item of value comprises at least one of a car related product and credit toward a purchase of a car related product.

52. The system of claim 47 further comprising means for transferring said used vehicle floor mat to a recycle center, means for processing said used vehicle floor mat, and means for transferring said processed used vehicle floor mat to a manufacturer of products.

53. The system of claim 52 wherein said means for transferring said used vehicle floor mat to a recycle center comprises means for transferring said used vehicle floor mat from a car dealer to a parts distribution center and means for transferring said used vehicle floor mat from said parts distribution center to said recycle center.
